(19) United States
(12) Patent Application Publication
(10) Pub. No.: US 2021/0365370 A1
(43) Pub. Date: Nov. 25, 2021

(54) MEMORY FOR STORING DATA BLOCKS

(71) Applicant: Imagination Technologies Limited, Kings Langley (GB)

(72) Inventors: Andrew SCOTT-JONES, Kings Langley (GB); Carlo PAPARO, Kings Langley (GB)

(21) Appl. No.: 17/326,184

(22) Filed: May 20, 2021

(30) Foreign Application Priority Data
May 20, 2020 (GB) 2007499.3

(51) Int. Cl. G06F 12/06; G06F 16/22

(52) U.S. Cl. CPC G06F 12/0646; G06F 2212/1041; G06F 16/2246

(57) ABSTRACT

A mechanism for storing data blocks in memory space. The memory space is divided into a plurality of memory buffers of two or more different predetermined sizes. Thus, the size and location of memory buffers (within the memory space) are pre-allocated. An index is generated that identifies a size and availability of each memory buffer in the divided memory space. Each index entry of the index corresponds or maps to a different memory buffer. A data block can be stored in the memory space by processing the index to identify a suitable memory buffer for storing the data block.

### BACKGROUND

The present disclosure relates to the field of memory for storing data, and in particular to mechanisms for configuring a memory to store data blocks.

A number of processes performed by electronic devices require the (temporary) storage of data blocks. For example, typical communication protocols may require temporary storage of communication data when setting up a communication link, or may require memory buffers to buffer data before it is sent over the communication link.

There are a number of existing methods for allocating memory for storing data blocks. These methods typically comprise dynamic allocation of memory space, for example, by identifying a data block to be stored and then allocating some memory space for storing a data block based on the size and/or storage requirements of the data block.

Typical dynamic memory allocation processes (such as the “malloc” process used by C or C++ programming languages) require significant resource overhead for managing the allocation, freeing allocated memory (when no longer required) and defragmenting the memory space. The need for these actions can slow down the performance of the electronic device, or require larger processing resources (e.g. a larger RAM or other processing module) to perform a desired process effectively.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The disclosure proposes a mechanism for storing data blocks in memory space. The memory space is divided into a plurality of memory buffers of two or more different predetermined sizes. Thus, the size of memory buffers (within the memory space) are pre-allocated. An index is generated that identifies a size and availability of each memory buffer in the divided memory space. Each index entry of the index corresponds or maps to a different memory buffer. A data block can be stored in the memory space by processing the index to identify a suitable memory buffer for storing the data block.

The disclosure proposes a computer-implemented method of pre-allocating memory for storing data blocks.

The computer-implemented method comprises: dividing memory space into a plurality of memory buffers of two or more different predetermined sizes; and generating an index comprising a plurality of index entries, each associated with a different memory buffer.

Each index entry identifies: the size of the associated memory buffer and an availability of the associated memory buffer.

In some examples, each of the plurality of memory buffers is configured, whilst they are identified by the index, to be indivisible during subsequent use of the plurality of memory buffers.

The step of dividing memory space may further comprise configuring each memory buffer to be invisible.

The total number of the plurality of memory buffers may be predetermined. Optionally, the two or more different sizes comprises five or more different sizes, e.g. twenty or more different sizes.

The index may comprise a tree-based data structure, each node of the tree-based data structure comprising a different index entry. In some embodiments, the position of each index entry within the tree-based data structure is based upon the size of its associated memory buffer. In particular, the index may consist of or be a tree-based data structure, i.e. all index entries of the index form part of the tree-based data structure.

In some examples, each index entry further identifies the location of the associated memory buffer in the memory space.

Each index entry may comprise a flag indicating the availability of the associated memory buffer. The flag may comprise a binary flag indicating whether or not the associated memory buffer is in use

The memory space may comprise at least one portion of memory space from a first memory, and at least one portion of memory space from a second, different memory. In such examples, the step of generating an index may comprise a plurality of index entries comprises generating a plurality of sub-indexes, each sub-index being associated with a different memory and each comprising a plurality of the index entries.

In some examples, the first memory is a first type of memory, and the second memory is a second, different type of memory. In such examples, the step of generating an index comprising a plurality of index entries comprises generating a plurality of sub-indexes, each sub-index being associated with a different type of memory and each comprising a plurality of the index entries.

There is also proposed a computer-implemented method of storing a data block in a memory buffer, the method comprising identifying a size of the data block; obtaining an index comprising a plurality of index entries, each associated with a different memory buffer, wherein each index entry identifies the size of the associated memory buffer and an availability of the associated memory buffer (e.g. generated by a previously described method); searching the index, using the identified size of the data block, to identify an index entry associated with a particular memory buffer, being a memory buffer that is able to store the data block; and storing the data block in the particular memory buffer.

The method may be adapted to, in response to storing the data block in the particular memory buffer, configure an availability of the particular memory buffer identified by the identified index entry to indicate that the particular memory buffer is unavailable. The identified index entry remains in the index after the data block is stored.

Optionally, the step of searching the index to identify an index entry associated with a particular memory buffer comprises identifying an index entry (in the index) that indicates that its associated memory buffer is not identified as being unavailable and is of sufficient size to store the data block.

The step of searching the index to identify a particular memory buffer may comprise identifying the index entry associated with the smallest sized memory buffer able to store the data block.

In some embodiments, the step of obtaining an index comprising obtaining an index an index comprising a plurality of index entries, each associated with a different memory buffer, wherein the memory buffers associated with the plurality of index entries are distributed across at least two different memories and/or types of memory; and the method may further comprise a step of identifying a desired memory and/or desired type of memory for storing the data block; and the particular memory buffer is a memory buffer able to store the data block and is located in the desired memory and/or desired type of memory.

There is also proposed a computer-implemented method of storing a first data block and a second, different data block in a memory, the computer-implemented method comprising: storing the first data block by performing a previously described method; identifying a size of the second data block; searching the index, using the identified size of the second data block, to identify a second index entry associated with a second particular memory buffer, being a memory buffer that is able to store the second data block, wherein the step of searching the index is further based upon a location of the index entry, associated with the particular memory buffer in which the first data block was stored, within the index; and storing the data block in the second particular memory buffer.

There is also proposed a method of performing a data block storage process (i.e. a memory allocation process), the method comprising: storing at least one data block in memory space by performing any previously described method one or more times; in response to an indication that there is no longer a desire to store a stored data block: identifying the index entry of the index associated with the memory buffer that stores the stored data block; and configuring an availability of the memory buffer identified by the identified index entry, associated with the memory buffer that stores the stored data block, to indicate that the memory buffer that stored the stored data block is available.

The method may be adapted to, in response to an indication that the memory buffers are no longer required, reconfigure each memory buffer to be divisible. This embodiment may be performed if, when index was generated, the step of dividing memory space comprised configuring each memory buffer to be indivisible.

There is also proposed a non-transitory machine readable storage medium storing machine readable instructions which, when executed by a processing system, cause the processing system to perform all the steps of any herein described method.

There is also proposed a memory allocator system configured to perform any previously described method.

Accordingly, there may be a memory allocator system configured to pre-allocate memory for storing data blocks, the memory allocator system being configured to: divide memory space into a plurality of memory buffers of two or more different predetermined sizes; and generate an index comprising a plurality of index entries, each associated with a different memory buffer, wherein each index entry identifies the size of the associated memory buffer; and an availability of the associated memory buffer.

Similarly, there may be a wireless communication system configured to perform a previously described method. For example, there may be a wireless communication process, the wireless communication system comprising: performing a wireless communication process, using a wireless communication module, that requires the storage of one or more data blocks in memory space; during the performance of the wireless communication process, storing, using a memory allocator system, at least one data block in memory space by performing a previously described method one or more times.

The memory allocator system may be embodied in hardware on an integrated circuit. There may be provided a method of manufacturing, at an integrated circuit manufacturing system, a memory allocator system. There may be provided an integrated circuit definition dataset that, when processed in an integrated circuit manufacturing system, configures the system to manufacture a memory allocator system. There may be provided a non-transitory computer readable storage medium having stored thereon a computer readable description of a memory allocator system that, when processed in an integrated circuit manufacturing system, causes the integrated circuit manufacturing system to manufacture an integrated circuit embodying a memory allocator system.

There may be provided an integrated circuit manufacturing system comprising: a non-transitory computer readable storage medium having stored thereon a computer readable description of the memory allocator system and/or wireless communication module; a layout processing system configured to process the computer readable description so as to generate a circuit layout description of an integrated circuit embodying the memory allocator system and/or wireless communication module; and an integrated circuit generation system configured to manufacture the memory allocator system and/or wireless communication module according to the circuit layout description.

In some embodiments, the layout processing system is configured to determine positional information for logical components of a circuit derived from the integrated circuit description so as to generate a circuit layout description of an integrated circuit embodying the memory allocator system and/or wireless communication module.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows a computer-implemented method according to an embodiment;

FIG. 2 shows a tree-based data structure for use in an embodiment;

FIG. 3 illustrates a system according to an embodiment;

FIG. 4 illustrates a system according to another embodiment;

FIG. 5 shows a computer system in which a memory allocator system is implemented; and

FIG. 6 shows an integrated circuit manufacturing system for generating an integrated circuit embodying a memory allocator system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

The present disclosure proposes a mechanism for storing data blocks in memory space. The memory space is divided into a plurality of memory buffers of two or more different predetermined sizes. Thus, the size (and location) of memory buffers (within the memory space) are pre-allocated. An index is generated that identifies a size and availability of each memory buffer in the divided memory space. Each index entry of the index corresponds or maps to a different memory buffer. A data block can be stored in the memory space by processing the index to identify a suitable memory buffer for storing the data block.

The present disclosure relies upon the recognition that the time and memory resources required to host and run a memory allocator system (e.g. on a processing module such as RAM) can cause significant overhead and can act as a bottleneck in fast performance of a process that requires (temporary) storage of data blocks, such as a communication process. The disclosure proposes to pre-allocate memory buffers of two or more different predetermined sizes, and provide an index for these memory buffers. This facilitates simple and low-complexity identification of a memory buffer for storing a data block, reducing overhead for managing the allocation.

The proposed mechanism also avoids a need to defragment a memory space and/or remove obsolete portions of the memory space (i.e. associated with no longer required data blocks), as use of an index facilitates low complexity identification of available memory buffers in the memory space.

The herein proposed mechanism provides a good balance between storage efficiency (as the probable required sizes of memory buffers can be established in advance) and speed or power usage for storing a data block in memory space (as computationally expensive memory allocation processes and/or steps, such as defragmentation, are avoided)

Embodiments may be employed in any electronic device that requires one or more memory buffers to perform an operation, such as a (wireless) communication module (e.g. a Bluetooth® module or a WiFi® module).

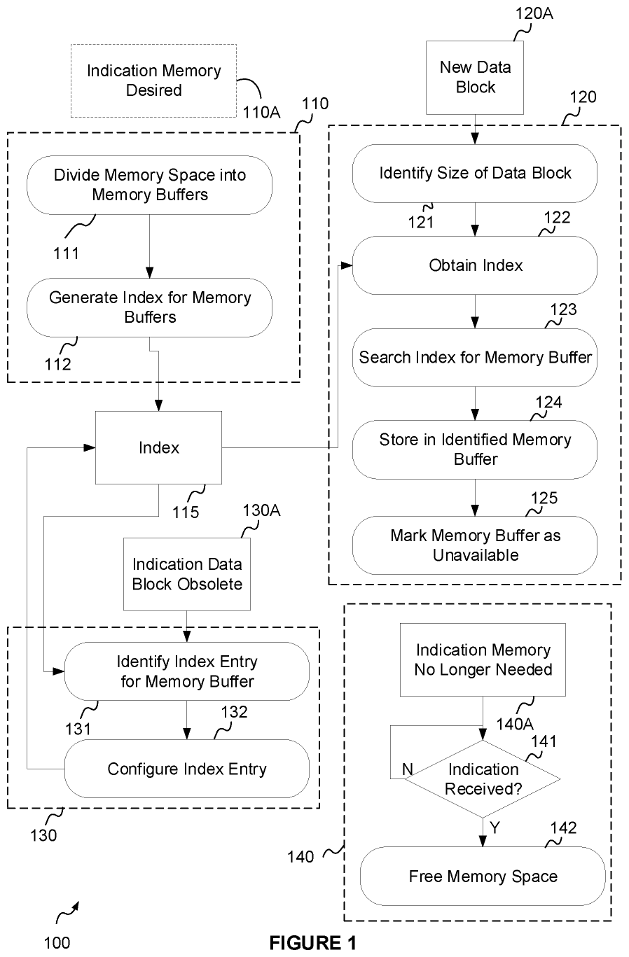

FIG. 1 is a flowchart illustrating a method 100 according to an embodiment. The method 100 is a memory allocation process, i.e. a method for performing a data block storage process.

Processing steps are illustrated with rounded rectangles, with data (elements) illustrated with non-rounded rectangles.

The method 100 may be performed by a memory allocator system, e.g. of an electronic device, that is configured to control the storage of one or more data blocks for a processing module.

The method 100 comprises a process 110 for pre-allocating memory for storing data blocks. The process 110 is, by itself, an embodiment of this disclosure.

The process 110 comprises a step 111 of dividing memory space into a plurality of memory buffers of two or more different predetermined sizes. Thus, step 111 comprises pre-allocating memory buffers in memory space before the size of data blocks (to be stored in the memory buffers) is known.

The memory space divided in step 111 comprises only blank, unused or obsolete data (i.e. data that would not affect an operation of the electronic device were the data to be overwritten).

The predetermined sizes can be selected or chosen based upon the use case scenario for the memory buffers. Different processes and/or devices that require (temporary) storage of data blocks will have different (average or statistical) storage requirements. A system designer would be capable of selecting appropriate predetermined sizes for the memory buffers based upon the implementation circumstances/context of the memory. The predetermined sizes may be in the region of 10 bytes to 10 kilobytes in size.

The number of memory buffers (in the plurality of memory buffers) may be predetermined and finite. In a similar manner to the predetermined sizes, the number of memory buffers may be selected based on the use case scenario for the memory buffers. Preferably, the number of memory buffers (generated by step 111) is no less than 5, for example, no less than 20, for example, no less than 50.

Thus, the number and/or sizes of the memory buffers may be dependent upon a use case scenario, for example, upon a (protocol for a) process and/or device that employs the storage of data. In other words, the size and/or number of the plurality of memory buffers may depend upon a storage strategy, which can vary depending upon the process and/or device that is to use the plurality of memory buffers to store data blocks. Thus, the number and/or size of the plurality of memory buffers may be dependent upon a (predetermined) task for which the plurality of memory buffers are to be used.

By way of example only, a Bluetooth module operating in a mode in which it makes only infrequent wireless queries would have very different buffer number/size requirements to a Bluetooth module operating in a mode in which it is actively managing multiple simultaneous connections. Thus, different processes (or combination of processes) performed by a same module may benefit from different configurations for the number/size of memory buffers.

As another example, a Wi-Fi communication module would benefit from a different combination of number/sizes of memory buffers to a Bluetooth communication module, as the storage/buffering requirements for these modules will differ due to the different wireless communication protocols used by the different communication modules.

Other examples for differing use case scenarios will be apparent to the skilled person.

Step 111 may further comprise preventing other memory allocator systems from using the space occupied by the predefined memory buffers. In other words, the space occupied by the memory buffers may be reserved (e.g. for a particular process and/or device) in step 111.

Step 111 may comprise configuring the memory buffers to be indivisible, e.g. during use of the memory space for the particular process and/or device.

The process 110 then moves to a step 112 of generating an index 115 comprising a plurality of index entries, each associated with a different memory buffer. Each index entry identifies: the size of the associated memory buffer; and an availability of the associated memory buffer.

The index 115 generated in step 112 thereby provides an index entry for each memory buffer generated in step 111. In this way, each index entry is associated with a respective memory buffer, and provides information on the associated memory buffer (e.g. to aid in selection of an appropriate pre-allocated memory buffer for a data block, as will be later described).

Each index entry may provide information on a size of the memory buffer with which it is associated. A size of the memory buffer may be indicated using a value, or may comprise a second pointer identifying an end of the memory buffer (which can be used to derive a size of the buffer).

Each index entry may also indicate an availability of the memory buffer, i.e. an indication of whether the memory buffer is in use or not. This may be indicated in the form of a simple (binary) flag (e.g. “0” indicates the buffer is not currently in use and “1” indicates that the buffer is in use) or other value. During an initial set up of the memory buffers, none of the memory buffers are considered to be in use (assuming that the memory space divided in step 111 is unused).

Each index entry may identify a location of the memory buffer (in the larger memory space) with which it is associated. A location of the memory buffer may be indicated, for example, using a pointer or the like. In another example, a location of the memory buffer may be indicated in an index entry using a location identifier or index identifier, which corresponds to an entry in a (separate) look-up table that identifies a location of the memory buffer associated with the index entry. Other examples would be apparent to the skilled person.

Preferably, step 112 comprises generating a tree-based data structure (or “tree”) as the index 115. The tree-based data structure may, for example, be a binary search tree (sometimes called an ordered or sorted binary tree). Each node of the tree-based data structure comprises a different index entry. A tree-based data structure facilitates simple and low complexity searching for a desired memory buffer (e.g. of an appropriate size) using the information stored by the index entries.

Thus, step 112 may comprise generating an index entry for each memory buffer, and storing the index entries in a tree-based data structure, such as a binary search tree. Preferably, the tree-based data structure is balanced or near-balanced, for further reducing the complexity of searching the tree-based data structure.

The tree-based data structure may be organised or arranged based on the size of the memory buffers associated with each index entry.

As will be known to the skilled person, a tree-based data structure is arranged to link all index entries together. In the context of a tree-based data structure, an index entry can be labeled a “node”.

A non-leaf node (index entry) branches or links to two child groups of one or more nodes. A first group is associated with index entries for memory buffers smaller than the memory buffer for said non-leaf node. A second group is associated with index buffers for memory buffers larger than or equal to (in size) the memory buffer for said non-leaf node.

A leaf node (index entry) or end node is a node without children.

In a balanced tree-based data structure, the nodes are arranged so that the distance between each leaf node and the first (or root) node is substantially the same (e.g. ±1 steps or ±2 steps).

Thus, a first node (or root node) of the tree may be associated with the index entry associated with the memory buffer having a median size—with nodes on the first branch from the first node being associated with memory buffers having a greater than median size, and nodes on the second branch from the first node being associated with memory buffers having a less than median size.

The skilled person would be readily capable of organising or generating a tree-based data structure that organises index entries based upon the size of the associated memory buffers.

Suitable algorithms for generating a tree-based data structure would be readily apparent to the skilled person. For example, an AVL tree generation algorithm could be used to provide a balanced tree (thereby reducing later tree searching complexity).

In other examples, the method 100 may re-use a tree generation algorithm used elsewhere by the electronic device, to reduce code memory usage. For example, a tree generation algorithm is used in (wireless) communication modules, such as Bluetooth-based communication modules, to generate a whitelist tree of devices.

Thus, in some embodiments, the step 112 of generating an index 155 comprises using a tree generation algorithm to generate a tree-based data structure of nodes (each node being a different index entry), wherein the tree generation algorithm is preferably used elsewhere for generating a different tree.

Other suitable indexes 115 would be apparent to the skilled person, although may be less preferred. One example of an alternative index is a list, e.g. which lists all index entries by order of size of the associated memory buffer. Another suitable example of an index is a hash(map) index.

From the foregoing, it will be apparent that the process 110 pre-allocates memory space into a plurality of memory buffers of different sizes (i.e. defines memory buffers within the memory space), and generates an index 115 that identifies the sizes and availability (e.g. used or available) of the memory buffers. The process 110 facilitates low-complexity storage of data blocks into a memory space, through use of the index to identify an appropriate, and pre-allocated, memory buffer for storing a data block.

The pre-allocation process means that any given pre-allocated memory buffer is usable to store only one chunk of data. A pre-allocated memory buffer, whilst it is identified by the index 115, is of a fixed size and is itself indivisible (i.e. cannot be further divided).

In other words, the memory is pre-allocated by dividing the memory space into a structure comprising a plurality of buffers of two or more different predetermined sizes, wherein the structure remains fixed (i.e. the buffers do not change in size) during the subsequent use of the memory. Put another way, the division of the memory space is static during the use of the memory. As a result, the structure of the index, with entries identifying the different memory buffers, remains constant during the use of the memory (although, of course, the index may be updated to indicate changing availabilities of the individual buffers).

The index 115 may further indicate the locations in the memory space of the memory buffers.

The process 110 may be initiated in response to an indication 110A that a device/module (of an electronic device) that performs a process that needs to store data blocks is powering up or is being otherwise activated (e.g. a communication module is powered up).

In another example, the process 110 may be initiated in response to an indication 110A that a process that needs to store data blocks is being initiated. For example, the process 110 may be performed in response to a process that needs to (temporarily) store data blocks (such as a communication process) being initiated.

Thus, the process 110 may be initiated in repose to an indication 110A that a process and/or device desires use of storage space to store one or more data blocks. However, other reasons and triggers for initiating the process 110 will be apparent to the skilled person.

The method 100 also illustrates a process 120 for storing a data block 120A in a memory buffer defined or allocated by the process 110 previously described. The process 120 is, itself, an embodiment of the present disclosure.

The process 120 comprises a step 121 of determining or identifying a size of the data block 120A to be stored. This information may, for example, be contained in header information or metadata of the data block. In other examples, the data block is analysed to determine its size. In yet other example, a storage instruction (for storing the data block) may identify a size of the data block to be stored.

The process 120 further comprises a step 122 of obtaining an index 115 generated by process 110.

The process 120 further comprises a step 123 of searching the index 115, using the identified size of the data block, to identify an index entry associated with a particular memory buffer. The particular memory buffer is a memory buffer that is capable of storing the data block (e.g. is of sufficient size to store the data block).

Preferably, the particular memory buffer is not marked (by the corresponding index entry) as being unavailable or “in use”. This ensures that memory buffers that are already in use are not overwritten. Preferably, the particular memory buffer is the smallest sized memory buffer capable of storing the data block. This increases a storage efficiency of the process 120.

Thus, step 123 may effectively comprise identifying the smallest sized memory buffer (a “particular memory buffer”) that can store the data block to be stored (i.e. is the same or greater size that the data block to be stored), and is not currently being used to store another data block (of non-obsolete data).

Step 123 is performed by processing or searching the index for a suitable index entry. Methods of searching would be apparent to the skilled person, and generally depend upon the format of the index. For instance, methods for searching of a tree-based data structure (one example of an index) are well established in the prior art, typically having complexity O(log₂(n)).

The process 120 then moves to a step 124 of storing the data block in the particular memory buffer.

Step 124 may be performed, for example, by identifying a location of the particular memory buffer associated with the index entry in the memory space.

Step 124 may be performed using, if present, the location indicated by the corresponding index entry. Other methods of indicating a location of a memory buffer in memory space will be known to the skilled person (e.g. using a look-up table correlating index entries to the location of the corresponding memory buffer). Methods of storing data in a memory space, once a storage location is known, are well known and established in the prior art.

Preferably, the process 120 further comprises a step 125 of configuring the index entry, associated with the particular memory buffer, to indicate that the corresponding particular memory buffer is being used. This can prevent future data blocks from being stored to the particular memory buffer whilst the data stored by the particular memory buffer is not obsolete.

The process 120 may be repeated for each data block to be stored.

As a fall-back, if no (available) memory buffer indicated by the index is capable of storing the data block to be stored (e.g. the data block is too large), the method may revert or default to an alternative memory allocation system for allocating memory to store the data block, such as a memory allocation system known in the art.

It is noted that the designer of a system would be readily capable of selecting appropriate numbers and/or sizes of memory buffers to reduce the likelihood that there will be insufficient numbers of memory buffers for all use case scenarios for a particular module/process. Indeed, providing sufficient memory, whatever the allocation system, would be an issue that system designers skilled in the art would be familiar with.

In other examples, the method may perform a step of defining a new memory buffer in the memory space, suitably sized to fit the data block to be stored.

In some examples, when a new memory buffer has been defined, a new index entry for the new memory buffer is added to the index. The index may thereby be updated or reconstructed based on the new index entry. This approach is advantageous as it can be assumed that the new memory buffer (of the appropriate size) may be required in the future (as it is likely that data blocks of a similar size will be provided in the future), and facilitates low complexity assignment of such future data blocks.

In some examples, where process 120 is repeated a number of times (e.g. for multiple data blocks), step 123 comprises initiating a search of the index at the position of the index entry associated with the memory buffer in which the previous data block was stored. It is herein recognised that consecutive data blocks to be stored are likely to be of a similar size. Thus, initiating a search at the position of the most recently used index entry can, on average, reduce the number of processing steps required to perform a search for a suitable memory buffer.

The method 100 may comprise a process 130 of marking previously used memory buffers as available, e.g. in response to an indication 130A that a stored data block is obsolete or no longer required—i.e. there is no longer a desire to store a stored data block (e.g. the data block has been retrieved and used by a process/device).

The process 130 comprises a step 131 of identifying the index entry of the index associated with the memory buffer that stores the data block (for which there is no longer a desire to store it). The process 130 also comprises a step 132 of configuring the identified index entry so that it indicates that the memory buffer (that stored the data block) is available or free. Thus, step 132 configures an availability of the memory buffer identified by the identified index entry, associated with the memory buffer that stores the stored data block, to indicate that the memory buffer that stored the stored data block is available.

This frees up the previously used memory buffer for storing a future data block, without the need to overwrite the data block or defragment the memory space (as may be required by typical memory allocator systems).

The proposed mechanism for effectively marking memory buffers as used or unavailable in the index (through appropriate modification of the corresponding index entry) means that the index does not need to be reconstructed (e.g. a tree rebalanced or a list re-ordered) in response to a data block being stored in a memory buffer. This reduces processing resource, and makes the memory allocation process more efficient.

Moreover, returning memory buffers to the index is extremely efficient, as this simply involves modifying the appropriate index entry (e.g. clearing a flag) to mark the memory buffer as available or free. This avoids the need to reconstruct the index.

The method 100 may be further adapted to respond to an indication 140A that the memory buffers are no longer required (e.g. if a device/module that requires the memory buffers to perform a process has completed the process or has been powered down or deactivated) by freeing the portion of memory space used for the memory buffers for other memory allocation processes. The detection of whether the memory buffers are no longer required may be performed by a detection step 141, with the freeing step performed in response thereto in a step 142. The method may also delete the generated index, which may be performed as an aspect of step 142.

Thus, a method may comprise a process 140 of responding to an indication 140A that the memory buffers are no longer required or desired.

Thus, the method 100 may end in response to an indication that the memory buffers are no longer required, e.g. the device and/or process that required the memory buffers is no longer active.

Preferably, all index entries in the index are maintained (i.e. not deleted) until the indication 140A is received. Thus, rather than deleting index entries, e.g. removed from a tree-like structure, when data is stored to the corresponding memory buffers, the index entries may be maintained in the index until the indication 140A is received, indicating that none of the memory buffers are required.

In some examples, each memory buffer is indivisible (e.g. into multiple memory buffers) once the memory space has been allocated and divided by step 111 until an indication 140A is detected. In particular, step 111 may comprise configuring each memory buffer to be indivisible (as previously described) and step 140 may comprise reconfiguring each memory buffer to be divisible. Thus, whilst the index is in use, each memory buffer identified by the index may be indivisible.

In some examples, there is a dedicated memory space that is divided into the memory buffers using the method 100. In particular, the dedicated memory space may be reserved or pre-designated for use with memory buffers generated for the method 100. In some examples, the entire dedicated memory is divided into buffers (when performing the method 100), with the size and/or number of buffers depending upon the use case scenario for the method 100.

Thus, the dedicated memory space may be (semi-)permanently reserved for the buffers, i.e. (semi-)permanently divided into the plurality of memory buffers.

The method 100 may be repeated for different processes and/or devices that require the (temporary) storage of data blocks. Each process and/or device may be associated with its own group of memory buffers.

In some examples, if method 100 has previously been performed for a particular process and/or device (e.g. but the corresponding memory buffers were subsequently marked free in a step 142), the steps of a subsequent iteration of method 100 may be dependent upon actions (or non-actions) performed in a previous iteration of method 100 for that process and/or device.

For instance, step 111 of dividing memory space into a plurality of memory buffers of two or more different predetermined sizes may be adapted so that the memory buffers further includes memory buffers that correspond to any new memory buffer generated in a previous iteration of the method 100. In other words, the memory buffers of two or more different predetermined sizes may include memory buffers that correspond (in size and number) to all memory buffers initially generated for a previous iteration, as well as any additional memory buffers generated during a memory allocation process. This concept anticipates the likely need for the process and/or device to use such an additional buffer.

As another example, step 111 of dividing memory space into a plurality of memory buffers of two or more different predetermined sizes may be adapted so that the plurality of memory buffers do not include memory buffers corresponding to memory buffers that were unused in a previous iteration of the method 100. In other words, the memory buffers of two or more different predetermined sizes may exclude memory buffers that correspond (in size and number) to memory buffers that were unused in a previous iteration of method 100 for that process and/or device. This embodiment improves a storage efficiency of the system by iteratively converging on buffer sizes most appropriate to that process and/or device.

Thus, a storage strategy (for defining memory buffers for a particular process and/or device) may learn from previous iterations of the method 100, i.e. the failures and successes of previous storage strategies for a particular process and/or device.

In some embodiments, the memory space is formed from two or more distinct and/or separate memories (i.e. physically separate memories) and/or two or more types of memory.

In some examples, the two or more different memories may comprise different types of memory (e.g. FLASH memory or DRAM). In other words, the memory space may comprise at least one portion of memory space from a first type of memory, and at least one portion of memory space from a second, different type of memory.

In some examples, the memory space used by the memory buffers is distributed within a single memory (from the two or more distinct memories). The choice of memory space (from the two or more distinct and/or separate memories) used for the method 100 may, for example, be defined by the process and/or device requiring the memory, e.g. picking a memory space based upon a latency of the memories and/or an available storage space of the memories.

In other examples, the method 100 may comprise dividing memory space that spans two or more different, distinct memory spaces into memory buffers. In other words, the memory space used by the memory buffers may be distributed across two or more distinct memories. This can facilitate, for example, later selection of a memory buffer based on desired characteristics of a memory (e.g. latency, write/read speeds or the like).

In some examples, the method 100 may comprise dividing memory space that spans across two or more different types of memory into memory buffers. This can facilitate, for example, selection of a memory buffer based on a desired type of memory for a particular block of data.

The method 100 may differ in that the step 112 of generating an index comprising a plurality of index entries comprises generating a plurality of sub-indexes, each sub-index being associated with a different distinct memory and each comprising a plurality of the index entries. Thus, for example, a different tree-based data structure may be generated for each distinct memory.

In examples, when performing process 120, the method may comprise selecting a sub-index from which an index entry (for a memory buffer) is to be selected. This selection may be performed based on the desired characteristics for a memory (e.g. based on a latency or read/write time of a memory associated with a particular sub-index).

In some examples, the method may comprise generating an index comprising a plurality of sub-indexes, each associated with a different type of memory. In this example, each sub-index may be associated with one or more distinct/separate memories (e.g. if the different memories are of the same type). In this way, a different tree-based data structure may be generated for each type of memory.

In some examples, e.g. where there is more than one type of memory, when performing process 120, the method may further comprise a step (not shown) of identifying a desired type of memory for the data block to be stored, where the particular memory buffer (for storing the data block) is a memory buffer able to store the data block and is located in data portion having the desired type of memory. Thus, the method may comprise processing the sub-indexes (associated with a particular type of memory) to identify a memory buffer in the appropriate type of memory that is able to store the data block (and is available for storage).

In some embodiments, if no memory buffer in the desired type of memory is able to store the data block, the process 120 may search for a memory buffer in a different type of memory that can store the data block (e.g. the smallest available memory buffer in another type of memory), and store the data block in the identified memory buffer.

In some embodiments, additional memory buffers (of predetermined sizes and/or numbers) may be defined in the memory space, and corresponding additional index entries for the additional memory buffers added to the index. This may comprise reconstructing the tree.

This process of adding additional index entries to an existing index may be useful if a process and/or device that uses the existing index indicates a desire to use additional memory (e.g. if it needs to perform a particular sub-process or activate a new module of the device).

Thus, in an embodiment, there is a process of responding to an indication that additional memory is required/desired by dividing some further memory space into additional memory buffers (preferably of two or more different predetermined sizes), generating an additional index entry for each additional memory buffer and adding the additional index entries to an existing index.

The additional index entries are analogous to the existing index entries, e.g. indicate the same information about their associated additional memory buffers as the existing index entries in the index.

The size and/or number of the additional memory buffers may be dependent upon the use case scenario (e.g. the sub-process and/or module that requires/desires storage of additional data blocks), in a manner analogous to the existing memory buffers as previously described.

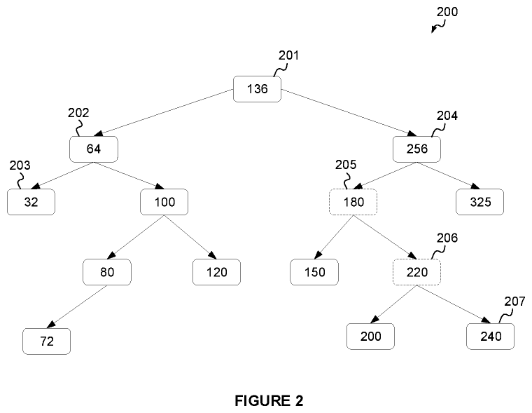

FIG. 2 illustrates a simplified index 200 for use in an embodiment.

The index 200 is in the form of a tree-based data structure (or simply “tree”), here a binary search tree, where each node 201-207 of the tree represents a different index entry. Example values for sizes of memory buffers (in bytes) associated with each index entry are also illustrated for improved conceptual understanding.

Only a sub-set of the nodes 201-207 of the tree 200 have been labeled in FIG. 2 for the purposes of later explanation. It will also be apparent that, in an implementation, more than the illustrated number of nodes may be present in the index.

The index 200 has been generated following the approach previously described with reference to FIG. 1, in particular process 110. Two of the index entries (illustrated with dashed lines) indicate that the corresponding memory buffer is in use, i.e. is unavailable.

The index can be searched for an index entry associated with the smallest available memory buffer that can store (i.e. is sufficiently large to store) the data block. Each (non-leaf) node points, links or branches to (one or) two other nodes. A first link/branch (illustrated: to the left) from a node directs towards an index entry (node) associated with a smaller memory buffer—i.e. a “smaller than” branch/link, and a second link/branch (illustrated: to the right) directs towards an index entry associated with a larger or same-sized memory buffer—i.e. a “larger than or same sized” branch/link.

An example (basic) search algorithm will be hereafter described in brief, for improved contextual understanding, although the skilled person would be readily capable of using any other suitable search algorithm. It is initially assumed, for the purpose of understanding, that all memory buffers are available (i.e. not in use), but it will be appreciated how the search algorithm could be modified to account for unavailable memory buffers (and examples are discussed later).

The example search algorithm may comprise performing a first search process. The first search process comprises checking the size of the (memory buffer associated with the) current index entry and moving to the next index entry based on a comparison between the required size (for storing the data block) and the size of the memory buffer associated with the current index entry. If a size of the memory buffer associated with the current index entry is less than the required size (for storing the data block), the first search process moves to a connected larger index entry. If a size of the memory buffer associated with the current index entry is greater than the connected index entry, the first search process moves to a connected smaller index entry. If a size of the memory buffer associated with the current index entry is equal to the required size (for storing the data block), the action taken may depend on the search algorithm (see next paragraph)—but if searching is to continue then the first search process moves to a connected larger index entry (in the current example structure).

The first search process is terminated in response to no further moves being available, i.e. when there are no connected smaller index entries if a smaller index entry is desired or there are no connected larger index entries if a larger index entry is desired. In some examples, the first search process may also be terminated if the size of the memory buffer associated with the current index entry is identical in size to the required size (for storing the data block). The index entry that the search algorithm is on, when the first search process ends or is terminated, may be labeled a first search index entry.

If the memory buffer associated with the first search index entry is the same size as the required size, the search algorithm selects the memory buffer associated with the first search index entry for storing the data.

If the memory buffer associated with the first search index entry for the said leaf node is unable to store the data block (e.g. it is too small), the search algorithm may backtrack to an index entry (e.g. previously identified during the first search process) associated with a memory buffer suitably sized (e.g. a buffer that might be larger than required, but is available) to store the data block.

If the size of the memory buffer associated with the first search index entry is greater than the size of the data block to be stored, and no previously identified (during the search algorithm) index entry was associated with a smaller memory buffer that was capable of storing the data block (i.e. was sized to store), the search algorithm may select the memory buffer of the first search index entry for storing the data block.

If the size of the memory buffer associated with the index entry for the said leaf node is greater than the size of the data block to be stored, and a previously identified (during the search algorithm) index entry was associated with a smaller memory buffer that was capable of storing the data block (i.e. was sized to store), the index entry the search algorithm may backtrack to the previously identified index entry and select the memory buffer of the previously identified index entry for storing the data block.

In this way, the search algorithm is able to identify the smallest memory buffer capable of storing (i.e. sufficiently sized to store) the data block.

Methods for handling scenarios in which none of the memory buffers associated with any of the index nodes are capable of storing (i.e. sufficiently sized to store) the required memory block have been previously described.

Search algorithms that also take into account an availability of a memory buffer associated with an index entry will be apparent to the skilled person.

For example, if a smallest memory buffer capable of storing is not available (e.g. already stores a non-obsolete or active data block), the search algorithm may search for a next smallest (or equally sized) available memory buffer.

This may be performed by, if an index entry associated with the smallest memory buffer sufficiently sized to store the data block points/links (via a branch) to an index entry associated with a larger memory buffer, repeating the first search process starting at the index entry associated with a larger memory buffer pointed to by the index entry associated with the smallest memory buffer.

In some examples, if an index entry associated with a smallest memory buffer sufficiently sized to store the data block does not point/link (via a branch) to an index entry associated with a larger memory buffer, the search algorithm may backtrack to an index entry sufficiently sized to store the required data block.

Other methods of accounting for an availability of a memory buffer will be apparent to the skilled person (e.g. and may be incorporated into the first search process).

Methods for handling scenarios in which no available memory buffer associated with any of the index nodes is capable of storing (i.e. sufficiently sized to store) the required memory block have been previously described.

For improved contextual understanding, a brief description of a number of examples for storing data blocks of different sizes using the above-described search algorithm shall be hereafter described.

In a first scenario, a process wishes to store a data block of size 50 bytes. The search algorithm performs the first search process, previously described, for this data block.

The size of the memory buffer associated with a first node 201 is 136 bytes, which is larger than the required value, so the search algorithm moves to a second linked/branched node 202 associated with a smaller memory buffer. This second node 202 is associated with a memory buffer of 64 bytes, which is also larger than the size of the required data block, so the search algorithm moves to a third linked/branched node 203 associated with a yet smaller memory buffer of 32 bytes. No further moves are available to the first search process, meaning that the third node would (if appropriately sized) be selected for storing the data block (as it would act as the first search index entry). However, the third node 203 is associated with a memory buffer that is unable to store the required data block (as it is too small—i.e. smaller than 50 bytes). The search algorithm therefore backtracks to the second node 202 (which is able to store the required data block) and identifies the memory buffer associated with the second node 202 for storing the data block.

In this first scenario, all of the nodes were associated with available (i.e. free) memory buffers, making selection of an appropriate node a relatively low complexity task.

In a second scenario, a process wishes to store a data block of size 220 bytes. The search algorithm again performs the first search process, previously described, for this data block.

The size of the memory buffer associated with the first node 201 is 136 bytes, which is smaller than the required value, so the search algorithm moves (along a “larger than or same sized” branch) to a fourth linked/node 204 which (by appropriate tree construction) will be associated with a larger or same sized memory buffer. The fourth node 204 is associated with a memory buffer of 256 bytes, which is larger than the size of the required data block, so the search algorithm moves (along a “smaller than” branch/link) to a fifth linked/node 205—which will be associated with a smaller memory buffer. The fifth node 205 is associated with a memory buffer of 180 bytes, which is smaller in size that the size of the required data block, so the search algorithm moves (along a “larger than or same sized” branch/link) to a sixth linked/branched node 206—which the search algorithm knows will be associated with a memory buffer of a larger or same size. The memory buffer associated with the sixth node 206 is 220 bytes, the same size as the required data block, so the search algorithm may select the memory buffer associated with the sixth node 206 (i.e. the sixth node becomes the first search index entry).

However, it is known that the memory buffer associated with the sixth node 206 is unavailable. The search algorithm therefore searches for an index entry associated with a next smallest buffer. This is performed by starting a search at the sixth node, which moves down the “larger than or same sized” branch/link to a seventh node 207, which is a leaf node (i.e. no further moves down the tree are available).

The search algorithm selects the memory buffer associated with the seventh node 207 to store the data block—as it is the smallest available memory buffer that can store the data block.

In a third scenario, a process wishes to store a data block of size 250 bytes. The search algorithm again performs the first search process, previously described, for this data block.

The size of the memory buffer associated with the first node 201 is 136 bytes, which is smaller than the required value, so the search algorithm moves (along a “larger than or same sized” branch) to a fourth linked/node 204 which (by appropriate tree construction) will be associated with a larger or same sized memory buffer. The fourth node 204 is associated with a memory buffer of 256 bytes, which is larger than the size of the required data block, so the search algorithm moves (along a “smaller than” branch/link) to a fifth linked/node 205—which will be associated with a smaller memory buffer. The fifth node 206 is associated with a memory buffer of 180 bytes, which is smaller in size that the size of the required data block, so the search algorithm moves (along a “larger than or same sized” branch/link) to a sixth linked/branched node 206—which the search algorithm knows will be associated with a memory buffer of a larger or same size. The sixth node 206 is associated with a memory buffer of 220 bytes, which is smaller in size than the size of the required data block, so the search algorithm moves (along a “larger than or same sized” branch/link) to a seventh linked/branched node 207—which the search algorithm knows will be associated with a memory buffer of a larger or same size. No further moves are available to the first search process, meaning that the seventh node would (if appropriately sized) be selected for storing the data block (as it would act as the first search index entry). However, the seventh node 207 is associated with a memory buffer that is unable to store the required data block (as it is too small—i.e. smaller than 50 bytes). The search algorithm therefore backtracks to the fourth node 204 (which is able to store the required data block and is available) and identifies the memory buffer associated with the fourth node 202 for storing the data block.

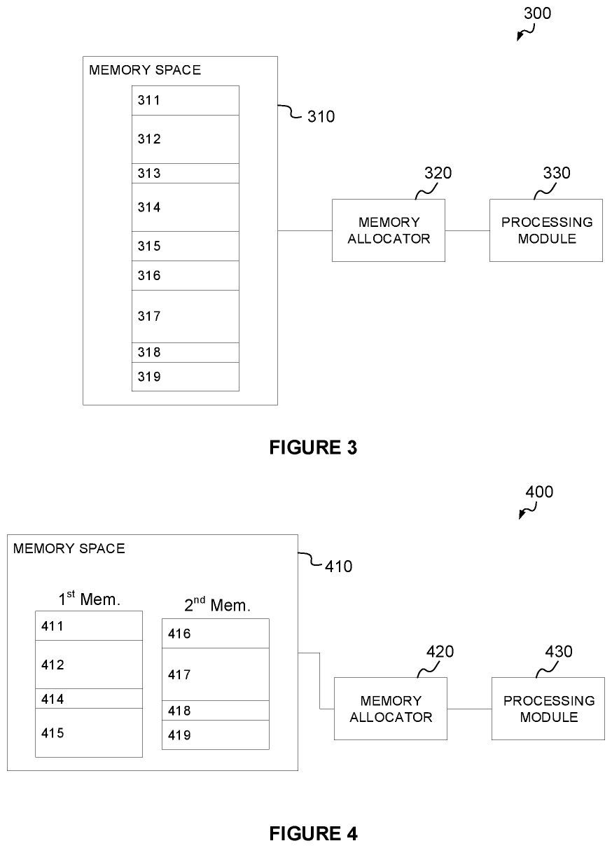

FIG. 3 is a block diagram illustrating (a portion of) a system 300 in which embodiments may be employed.

The system 300 comprises a memory space 310 (e.g. part of a large memory module, not shown) and a memory allocator system 320. A processing module 330 is configured to perform a process that requires the (temporary) storage of one or more data blocks.

In some preferred examples, the processing module 330 is a wireless communication module configured to perform a wireless communication process that requires the storage of one or more data blocks. This may be performed by communicating, or attempting to communicate, with other wireless communication modules. In this way, the system 400 may be a wireless communication system.

The memory allocator system 320 is configured to pre-allocate or pre-define memory buffers within the memory space 310, i.e. before the processing module requests a memory buffer for a data block to be stored.

In particular, the memory allocator system is configured to divide the memory space into a plurality of memory buffers 311-319 of two or more different predetermined sizes. Examples of suitable memory buffers are diagrammatically illustrated in FIG. 3 (demonstrating different sizes or extents for each (pre-defined) memory buffer).

The selection of the number of memory buffers and/or the predetermined sizes may be based upon the operation to be performed by the processing module 330, e.g. a protocol of the operation that the processing module is configured to perform, and/or a type of the processing module.

The memory allocator system 320 then generates an index comprising a plurality of index entries, each associated with a different memory buffer. Each index entry identifies: the size of the associated memory buffer; and an availability of the associated memory buffer. An index entry may further identify the location of the associated memory buffer in the memory space.

Suitable methods and processes for generating an index have been previously described, e.g. with reference to FIG. 1.

When the processing module 330 desires to (temporarily) store a data block, it passes a storage request to the memory allocator system. The memory allocator system 310 processes the index, using the storage request (indicating at least a size of the data block to be stored), to select one of memory buffers 311-319 in which to store the data block.

As previously noted, in the event that no memory buffer is capable of storing the data block (e.g. because all suitably sized (predefined) memory buffers are occupied, unavailable or non-existent), the memory allocator system may be configured to define a new memory buffer in the memory space for storing the data block.

When the processing module 330 no longer requires the storage of the data block, the corresponding memory buffer is marked as “free” or “available” in the index entry for that memory buffer. Thus, the freed memory buffer is made available for the storage of subsequent data blocks.

When the processing module no longer requires the storage of data blocks (e.g. a process that requires the storage is complete or the processing module 330 is powered down), the memory allocator system 320 may be configured to free or release (i.e. no longer reserve) the memory space (e.g. for use by other memory allocator systems or for defining memory buffers for other processes and/or devices).

FIG. 4 is a block diagram illustrating (a portion of) a system 400 in which embodiments may be employed. The system again comprises a memory space 310, a memory allocator system 420 and a processing module 440.

In some preferred examples, the processing module 440 is a wireless communication module configured to perform a wireless communication process that requires the storage of one or more data blocks. In this way, the system 400 may be a wireless communication system.

The system 400 differs from the previously described system 300 in that the memory space 410 is formed of two or more different distinct memories. In other words, the memory space may comprise at least one portion of memory space from a first memory, and at least one portion of memory space from a second, different memory.

The first memory may comprise a first type of memory, and the second memory may comprise a second, different type of memory.

The method performed by the memory allocator system may differ in that the step of generating an index comprising a plurality of index entries comprises generating a plurality of sub-indexes, each sub-index being associated with a different memory and each comprising a plurality of the index entries. Thus, for example, a different tree-based data structure may be generated for each memory.

In such an example, when storing a data block, the method further comprises a step of identifying a desired type of memory for the data block to be stored, where the particular memory buffer (for storing the data block) is a memory buffer able to store the data block and is located in data portion having the desired type of memory. Thus, the method comprises process the sub-indexes to identify a memory buffer in the appropriate type of memory that is able to store the data block (and is available for storage).

In some embodiments, if no memory buffer in the desired type of memory is able to store the data block, the memory allocator system may search for a memory buffer in a different type of memory that can store the data block (e.g. the smallest available memory buffer in another type of memory), and store the data block in the identified memory buffer.

It will be understood that disclosed methods are preferably computer-implemented methods. As such, there is also proposed the concept of computer program comprising code means for implementing any described method when said program is run on a processing system, such as a computer. Thus, different portions, lines or blocks of code of a computer program according to an embodiment may be executed by a processing system or computer to perform any herein described method. In some alternative implementations, the functions noted in the block diagram(s) or flow chart(s) may occur out of the order noted in the figures. For example, two blocks shown in succession may, in fact, be executed substantially concurrently, or the blocks may sometimes be executed in the reverse order, depending upon the functionality involved.

The skilled person would be readily capable of developing a memory allocator system, processing module (such as a wireless communication module) or other processing module/block for carrying out any herein described method. Thus, each step of the flow chart may represent a different action performed by a memory allocator system or processing module (such as a wireless communication module), and may be performed by a respective (sub-)module of the memory allocator system or processing module.

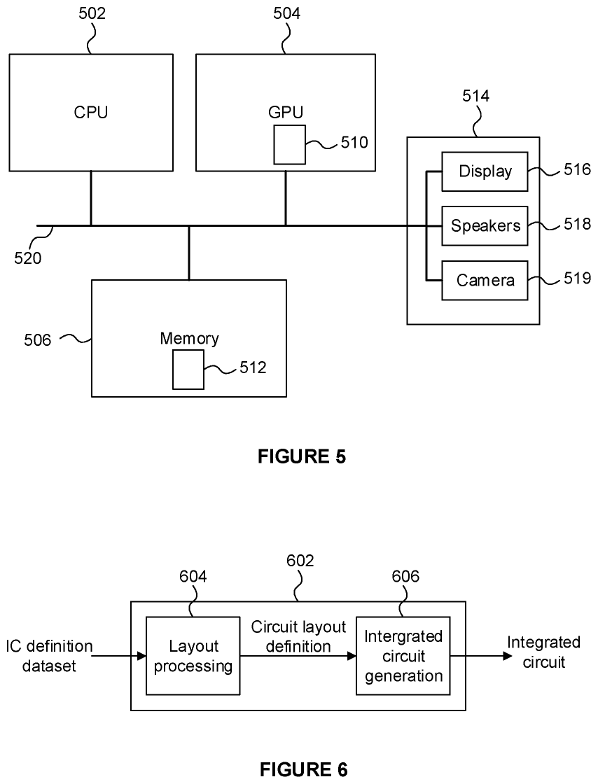

FIG. 5 shows a computer system in which the memory allocator system(s) described herein may be implemented. The computer system comprises a CPU 502, a GPU 504, a memory 506 and other devices 514, such as a display 516, speakers 518 and a camera 106. A processing block 510, for performing a memory allocation process previously described, may be implemented on the CPU 502. Thus, the processing block may implement the memory allocator system 320, 420. The components of the computer system can communicate with each other via a communications bus 520. A memory space 512 (corresponding to memory 310, 410) is implemented as part of the memory 506.

While FIG. 5 illustrates one implementation of a memory allocator system, it will be understood that a similar block diagram could be drawn for an artificial intelligence accelerator system—for example, by replacing either the CPU 502 or the GPU 504 with a Neural Network Accelerator (NNA), or by adding the NNA as an additional unit. In such cases, the processing block 510 can be implemented in the NNA.

The memory allocator system of FIGS. 1-4 are shown as comprising a number of functional blocks. This is schematic only and is not intended to define a strict division between different logic elements of such entities. Each functional block may be provided in any suitable manner. It is to be understood that intermediate values described herein as being formed by a memory allocator system need not be physically generated by the memory allocator system at any point and may merely represent logical values that conveniently describe the processing performed by the memory allocator system between its input and output.

The memory allocator systems or processing modules described herein may be embodied in hardware on an integrated circuit. The memory allocator systems or processing modules described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software that defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a memory allocator system or processing module configured to perform any of the methods described herein, or to manufacture a memory allocator system or processing module comprising any apparatus described herein. An integrated circuit definition dataset may be, for example, an integrated circuit description.

Therefore, there may be provided a method of manufacturing, at an integrated circuit manufacturing system, a memory allocator system or processing module as described herein. Furthermore, there may be provided an integrated circuit definition dataset that, when processed in an integrated circuit manufacturing system, causes the method of manufacturing a memory allocator system or processing module to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS® and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture a memory allocator system or processing module will now be described with respect to FIG. 6.

FIG. 6 shows an example of an integrated circuit (IC) manufacturing system 602 which is configured to manufacture a memory allocator system or processing module as described in any of the examples herein. In particular, the IC manufacturing system 602 comprises a layout processing system 604 and an integrated circuit generation system 606. The IC manufacturing system 602 is configured to receive an IC definition dataset (e.g. defining a memory allocator system or processing module as described in any of the examples herein), process the IC definition dataset, and generate an IC according to the IC definition dataset (e.g. which embodies a memory allocator system or processing module as described in any of the examples herein). The processing of the IC definition dataset configures the IC manufacturing system 602 to manufacture an integrated circuit embodying a memory allocator system or processing module as described in any of the examples herein.

The layout processing system 604 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 604 has determined the circuit layout it may output a circuit layout definition to the IC generation system 606. A circuit layout definition may be, for example, a circuit layout description.

The IC generation system 606 generates an IC according to the circuit layout definition, as is known in the art. For example, the IC generation system 606 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 606 may be in the form of computer-readable code which the IC generation system 606 can use to form a suitable mask for use in generating an IC.

The different processes performed by the IC manufacturing system 602 may be implemented all in one location, e.g. by one party. Alternatively, the IC manufacturing system 602 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a memory allocator system or processing module without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 6 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 6, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A computer-implemented method (110) of pre-allocating memory for storing data blocks, the computer-implemented method comprising:
dividing (111) memory space (310, 410) into a plurality of memory buffers (311-319, 411-419) of two or more different predetermined sizes; and
generating (112) an index (115, 200) comprising a plurality of index entries (201-207), each associated with a different memory buffer, wherein each index entry identifies the size of the associated memory buffer and an availability of the associated memory buffer.

2. The computer-implemented method (110) of claim 1, wherein the total number of the plurality of memory buffers is predetermined.

3. The computer-implemented method (110) of claim 1, wherein each of the plurality of memory buffers is configured, whilst they are identified by the index, to be indivisible during subsequent use of the plurality of memory buffers.

4. The computer-implemented method (110) of claim 1, wherein the step of dividing memory space further comprises configuring each memory buffer to be indivisible.

5. The computer-implemented method (110) of claim 1, wherein the two or more different sizes comprises: five or more different sizes or twenty or more different sizes.

6. The computer-implemented method (110) of claim 1, wherein the index (115, 200) comprises a tree-based data structure, each node (201-207) of the tree-based data structure comprising a different index entry.

7. The computer-implemented method (110) of claim 6, wherein the position of each index entry (201-207) within the tree-based data structure is based upon the size of its associated memory buffer.

8. The computer-implemented method (110) of claim 1, wherein each index entry comprises a flag indicating the availability of the associated memory buffer.

9. The computer-implemented method (110) of claim 8, wherein the flag comprises a binary flag indicating whether or not the associated memory buffer is in use.

10. The computer-implemented method (110) of claim 1, wherein the memory space (410) comprises at least one portion of memory space from a first memory, and at least one portion of memory space from a second, different memory.

11. The computer-implemented method (110) of claim 10, wherein the step of generating an index comprising a plurality of index entries comprises generating a plurality of sub-indexes, each sub-index being associated with a different memory and each comprising a plurality of the index entries.

12. A computer-implemented method (100) of performing a data block storage process, the computer-implemented method comprising;
identifying (121) a size of the data block;
obtaining (122) an index (115, 200) generated by performing the method (110) of claim 1;
searching (123) the index, using the identified size of the data block, to identify an index entry associated with a particular memory buffer, being a memory buffer that is able to store the data block; and
storing (124) the data block in the particular memory buffer.

13. The computer-implemented method (100) of claim 12, further comprising, in response to storing the data block in the particular memory buffer, configuring (125) an availability of the particular memory buffer identified by the identified index entry to indicate that the particular memory buffer is unavailable,
preferably wherein the step (123) of searching the index to identify an index entry associated with a particular memory buffer comprises identifying an index entry that indicates that its associated memory buffer is not identified as being unavailable and is of sufficient size to store the data block.

14. A computer-implemented method (100) of performing a data block storage process, the computer-implemented method comprising:
storing the first data block by performing the computer-implemented method of claim 12;
identifying a size of the second data block;
searching the index, using the identified size of the second data block, to identify a second index entry associated with a second particular memory buffer, being a memory buffer that is able to store the second data block,
wherein the step of searching the index using the identified size of the second data block, is further based upon a location of the index entry, associated with the particular memory buffer in which the first data block was stored, within the index; and
storing the data block in the second particular memory buffer.

15. The computer-implemented method (100) of claim 12, further comprising, in response to an indication (130A) that there is no longer a desire to store a stored data block:
identifying (131) the index entry of the index associated with the memory buffer that stores the stored data block; and
configuring (132) an availability of the memory buffer identified by the identified index entry, associated with the memory buffer that stores the stored data block, to indicate that the memory buffer that stored the stored data block is available.

16. A computer-implemented method (100) of performing a data block storage process, the computer-implemented method comprising;
identifying (121) a size of the data block;
obtaining (122) an index (115, 200) generated by performing the method (110) of claim 4;
searching (123) the index, using the identified size of the data block, to identify an index entry associated with a particular memory buffer, being a memory buffer that is able to store the data block;
storing (124) the data block in the particular memory buffer;
in response to an indication that the memory buffers are no longer required, reconfiguring each memory buffer to be divisible.

17. A computer-implemented method (100) of performing a wireless communication process, the computer-implemented method comprising:
performing a wireless communication process that requires the storage of one or more data blocks in memory space;
during the performance of the wireless communication process, storing at least one data block in memory space by performing the method of claim 12 one or more times.

18. A non-transitory machine readable storage medium storing machine readable instructions which, when executed by a processing system, cause the processing system to perform all the steps of the method of claim 1.

19. A memory allocator system (320, 420) configured to pre-allocate memory for storing data blocks, the memory allocator system being configured to:
divide (111) memory space (310, 410) into a plurality of memory buffers (311-319, 411-419) of two or more different predetermined sizes; and
generate (112) an index (115, 200) comprising a plurality of index entries (201-207), each associated with a different memory buffer, wherein each index entry identifies the size of the associated memory buffer; and an availability of the associated memory buffer.

20. The memory allocator system (320, 420) of claim 19 further configured to allocate and store a data block in a memory buffer, the memory allocator system being configured to:
identify (121) a size of the data block;
obtain (122) the generated index;
search (123) the index, using the identified size of the data block, to identify an index entry associated with a particular memory buffer, being a memory buffer that is able to store the data block; and
store (124) the data block in the particular memory buffer.
